(19) United States
(12) Patent Application Publication
(10) Pub. No.: US 2008/0175757 A1
(43) Pub. Date: Jul. 24, 2008

(54) Microarray device with elastomeric well structure

(76) Inventor: Andrew Powell, Somerville, MA (US)

Correspondence Address: GUERRY LEONARD GRUNE, 784 S VILLIER CT., VIRGINIA BEACH, VA, 23452, US

(21) Appl. No.: 11/655,806

(22) Filed: Jan. 19, 2007

(51) Int. Cl. B01J 19/00; B29C 45/02; B29C 43/00; B29C 45/14

(52) U.S. Cl. 422/68.1; 264/328.1

(57) ABSTRACT

A microarray device comprised of a base housing, a transparent plate, an elastomeric microarray structure with internal frame and optional top sealing plate. The microarray device enables the transparent bottom plate to be coated with a biological or pharmaceutical agent prior to device assembly forming a specified number of watertight reservoir wells.

### FIELD OF INVENTION

The field of the invention generally relates to microarray slides and glass bottom-microtiter plates, used in biosciences and pharmaceutical industries, more particularly to an elastomeric microarray assembly that enables the use of coated glass transparent bottom plates.

1. Background of Invention

Microarrays coupled with the instrumentation for manufacturing and reading spotted microarrays has spurred a revolution in the biology and life sciences industry. Spotting technology as evolved from cDNA to include spotting other materials, including small molecules, antibodies, oligonucleotides, proteins, enzymes, whole cells, and tissue specimens. To a large degree, the technology has now settled on several standard formats in part to facilitate high throughput robotics developed for biomedical and pharmaceutical research.

Microarray slides are generally manufactured on 25 mm by 75 mm glass slides approximately 1 mm thick. Wells in these plates are designed with standard spacing. A 96-well microtiter plate has twelve columns and eight rows with 9 mm spacing between the centers of adjacent wells. A 384-well microtiter plate has twenty-four columns and sixteen rows with 4.5 mm spacing between the centers of adjacent wells. A 1536-well microtiter plate has forty-eight columns and thirty-two rows with 2.25 mm spacing between the centers of adjacent wells. Pipetting and plate sterilizing or cleaning robots are designed to handle microtiter plates of this form factor of approximately 127.7 mm×85.5 mm.

The Society of Biomolecular Sciences (SBS) has provided standardized microtiter plate-microarray specifications enabling the industry to build automated microarray microscopy and inspection instruments designed for microarray-microtiter plates.

The evolution of microarray technology makes it desirable for the study of interaction between many different samples within a given microarray of materials. For example, one may want to screen thousands of different samples from patients with a microarray of 100 different antibodies. Or, one may wish to screen thousands of different small organic compounds for their ability to disrupt protein-protein interactions in a microarray of 100 different pairs of proteins. To do this, it is valuable to use the current instrumentation for preparing and scanning microarrays in combination with the current instrumentation for processing samples in microtiter plates.

2. Description of Prior Art

US Patent Application 2006/0171856, Jehle, et al. describes a polymer based microarray slide with compartments having bottoms and sidewall extending from the bottom. The platform and compartments are formed of a polymer material, such as polystyrene or cycloolefin or other plastic material. The sidewall has a low profile such ratio of surface area bottom to height of sidewall is greater than 30. Another embodiment has the surface of the slide coated with a reflective material.

Jehle invention has decided disadvantage of an optically inferior thermoplastic microarray well bottom surface and reservoir well sidewall. The disclosed invention has elastomeric well sidewalls that also function as a bottom sealing gasket when compressed against the bottom rigid sealing plate. The preferred embodiment of the invention disclosed within also employs a glass bottomed reservoir well surface to facility microarray reading by microscopy inspection equipment.

U.S. Pat. No. 7,097,809, Van Dam, et al. and assigned to California Institute of Technology describes a microfluidic device and method for synthesizing various compounds. The microfluidic device disclosed by VanDam employs two solid plates with a plurality of flow channels sandwiched around a multiple segmented elastomeric layer that separates flow channels from control channels. The elastomeric layer is deflectable or retractable from the fluid flow channel that it overlays and responds to an actuation force to control the flow channels.

The elastomeric reservoir well structure disclosed within is compressed against the solid plate via an internal frame and base housing graduated mechanical interface. Van Dam's device also requires channels for a microfluidic reaction to occur, the invention disclosed within is compatible with existing biomedical spotting and microscopy inspection equipment.

U.S. Pat. No. 7,063,979 MacBeath, et al. and assigned to Grace Bio Labs and Harvard College describes a process for preparing a microtiter-microarray device with bottomless microtiter plate attached through one or more adhesive gaskets. The devices and method disclosed by MacBeath in U.S. Pat. No. 7,063,979 requires the cumbersome step of assembling the microarray device with an adhesive-bonding layer between the sidewall microarray structure and the solid glass plate. The invention disclosed within is for a three element microarray structure that uses the compressible characteristics of the elastomer to form the watertight microarray reservoir wells. The elastomeric microarray structure is compressed against rigid plate instead of relying on an adhesive layer.

U.S. Pat. No. 6,987,019 Rogalsky, et al. describes a device for growing cells has a container with a specific geometry including a flat bottom, thin elongated plates which are inclined and spaced at predetermined distances. This plastic cell-growing container has the major disadvantage a being entirely produced in thermoplastic, lacking an optical glass bottom, making microscopy microarray inspection and accurate fluorescence measurements extremely difficult.

U.S. Pat. No. 6,818,438 Muser, et al. assigned to Becton, Dickinson and Company details a tissue culture flask includes a base, a cover and a cap produced from a rigid or semi-rigid plastic material. The geometry is designed to facilitate access by pipettes, scrapers and other instruments. As per U.S. Pat. No. 6,987,019 issued to Rogalsky, U.S. Pat. No. 6,818,438 issued to Muser is produced with thermoplastic yielding the same optical microscopy and fluorescence measurements issues.

U.S. Pat. No. 6,703,120 Ko, et al. assigned to 3M Innovative Properties Company describes in detail a Silicone adhesives, preferably pressure sensitive to attach microtiter plates, microfluidic devices, and multi-reservoir carriers, or other analytical receptacles or biosensors for example a glass plate or glass slide. The need for sealing tape or adhesive detailed by Ko in U.S. Pat. No. 6,703,120 is eliminated by the disclosed three element assembly including a rigid glass plate, a bottomless elastomeric structure with internal frame and base housing secured together with the aid of a mechanical latching mechanism.

U.S. Pat. No. 6,646,243 Pirrung, et al. assigned to Affymetrix, Inc describes a method and apparatus for preparation of a substrate surface with light activated monomers. The monomers contain a photoremovable group to bind to the substrate in selected areas. Similar to the adhesive disclosed in U.S. Pat. No. 6,703,120 by Ko the bonding method disclosed in U.S. Pat. No. 6,646,243 by Pirrung is not required to produce the mechanically latched microarray disclosed within.

U.S. Pat. No. 6,623,701 Eichele, et al. assigned to Max-Planck-Gesellschaft zur Forderung der Wissenschaften describes a specific specimen chamber with a wedge-shaped liquid reservoirs with spacer plates clamped together between a base plate and carrier plate. The disclosed invention does not create a wedge shaped reservoirs as detailed in U.S. Pat. No. 6,623,701 issued to Eichele.

U.S. Pat. No. 6,475,774 Gupta, et al. reveals a recloseable elastomeric cover sheet for multi-well plate microarrays. The cover sheet forms a tight seal between the cover and the microarray reservoir well plastic or rigid sidewalls. The invention disclosed herein can be sealed, isolating the individual microarray wells, with a simple rigid plate. The disclosed invention's elastomeric microarray structure function as the well sidewalls and a sealing gasket on both the reservoir well floor and well top allowing the user to replace the complex elastomeric cover sheet with a simple flat plate.

U.S. Pat. No. 6,423,536 Jovanovich, et al. assigned to Molecular Dynamics, Inc. describes a device comprised of a system of capillaries that open and close to allow air or reagent to flow to reaction reservoirs on a nanoscale. The automated system utilizes an array of reaction chambers whose ends of the chambers are temporarily sealed with deformable membranes. The invention defined within has a defined reservoir geometry and is designed to be watertight without flow between chamber wells.

U.S. Pat. No. 6,150,159 Fry, et al. describes a cell culture vessel with neck and removable closure member. The vessel is for tissue culture growth and produced from a sterilizable plastic material. As detailed in U.S. Pat. No. 6,987,019 issued to Rogalsky and U.S. Pat. No. 6,818,438 issued to Muser the device defined in U.S. Pat. No. 6,150,159 issued to Fry is produced from a plastic material with inherent optical microscopy and fluorescence measurements disadvantages compared to the rigid glass bottom that is the preferred embodiment of the invention defined within this application.

U.S. Pat. No. 6,037,168 Brown, et al. assigned to Cytonix Corporation describes a microbiological assembly having resealable seal between a support and a cover. Brown patent reveals several sealant material options with an objective of minimizing contamination in the devices sample retention well. The advantage of the disclosed device is the lack of a sealant, adhesive or priming agent.

U.S. Pat. No. 6,015,534 Atwood, et al. assigned to The Perkin-Elmer Corporation describes a one-piece cylindrical sample tube for use in a PCR thermal cycler for cell growth. The molded tube has a conical shoulder and produced from a sterilizable polypropylene. The polypropylene tube does not offer a transparent glass or rigid plate surface for optical microscopy and fluorescence measurements as previously mentioned.

Further objects and advantages will become apparent from consideration of the ensuing description and drawings.

### SUMMARY

The present disclosure provides a microarray device for testing of biological or pharmaceutical samples. The device is comprised of a base housing a rigid transparent bottom plate, a bottomless elastomeric microarray structure with internal frame and optional top sealing plate. The base housing and bottomless elastomeric microarray structure with internal frame mechanically latch together attaching the transparent bottom plate and forming a single microarray device with a specified number of watertight elastomeric microarray reservoir wells.

It is also the object of this invention to provide a microarray structure including, but is not limited to, 1, 2, 8, 16, 96, 384 or 1536 reservoir wells with a glass plate or other transparent bottom plate enabling microscopy inspection of individual reservoir wells.

It is also the object of this invention to formulate the elastomeric wells structure material with different opaque, transparent or translucent colors for various bioscience applications. It has been shown that white microarray structure allows for maximum luminescence reflection and minimal autoluminescence while black microarrays provide very low auto fluorescence.

It is also the object of this invention, in a preferred embodiment, to produce the elastomeric well structure from silicone rubber also known as PDMS.

It is also the object of this invention to produce a microarray device with a transparent bottom plate produced from rigid plate glass maintaining excellent optical quality across the flat bottom of the plate to facilitate automatic imaging, conforming to the requirements for microscopy microarray inspection.

Another embodiment of the invention is to produce the rigid plate from transparent thermoplastic or thermoset material.

It is also the object of this invention to enable the transparent rigid plate to be coated with a biological or pharmaceutical agent prior to microarray assembly.

It is also the object of this invention to provide watertight microarray well seals due to the compressive force generated by the latching mechanism attaching the transparent bottom plate to the microarray structure. The compressive force is generated via latching details fabricated within the base housing and bottomless elastomeric microarray internal frame. The compressive force is transferred through the bottomless elastomeric structure against the transparent bottom plate captured within the base housing.

It is also the object of this invention to fabricate the bottomless microarray structure with internal frame, with an integrated underside sealing gasket to facilitate the watertight seal of the bottomless elastomeric structure against the rigid plate.

It is also the object of this invention to fabricate the bottomless microarray structure with internal frame, with an integrated top sealing gasket to accommodate an optional top sealing plate providing the advantage of limiting individual reservoir well cross contamination.

It is also useful and instructive and an embodiment of this invention to provide a fit allowing a securely and precisely defined microarray or microtiter form factor, as defined by The Society of Biomolecular Sciences, accommodating existing bio-science spotting automation and equipment.

It is also instructive to adapt the reservoir well shapes to the desired form factor without limitations on the nature of the microarrays or on the shape and dimensions of either the wells or rigid plate.

It is also the object of this invention to mechanically latch the base housing and bottomless elastomeric microarray structure with internal frame to form a specified number of watertight elastomeric microarray reservoir wells. The compressive force generated by the latching interface creates a series of watertight seals against the transparent bottom plate.

It is instructive to state that the bottomless elastomeric structure with internal frame is manufactured by co-injecting or over-molding an elastomeric material onto an internal frame using compression, injection or transfer molding. The cooling or curing of the elastomeric material onto the internal frame creates a bond between the elastomeric structure and internal frame.

It is also instructive to product the internal frame from a rigid or semi-rigid metal, thermoplastic or thermoset material.

Further objects and advantages will become apparent from consideration of the ensuing description and drawings.

### DRAWINGS

FIG. 1 is a perspective view of a bottomless 96 reservoir well-single element microarray with overmolded internal frame.

FIG. 2 illustrates the internal frame encapsulated by the elastomeric microarray.

FIG. 3 illustrates an exploded assembly drawing of a 96 reservoir well microarray device.

FIG. 4 illustrates a cross sectional, close-up view of the latching mechanism interface between the base and internal frame of the bottomless 96 well microarray structure.

FIG. 5 illustrates a cross sectional, close-up view of an individual reservoir of an assembled 96 well microtiter microarray apparatus.

FIG. 6 is a perspective view of an assembled 96 reservoir well microarray apparatus.

### DESCRIPTION OF THE DRAWINGS

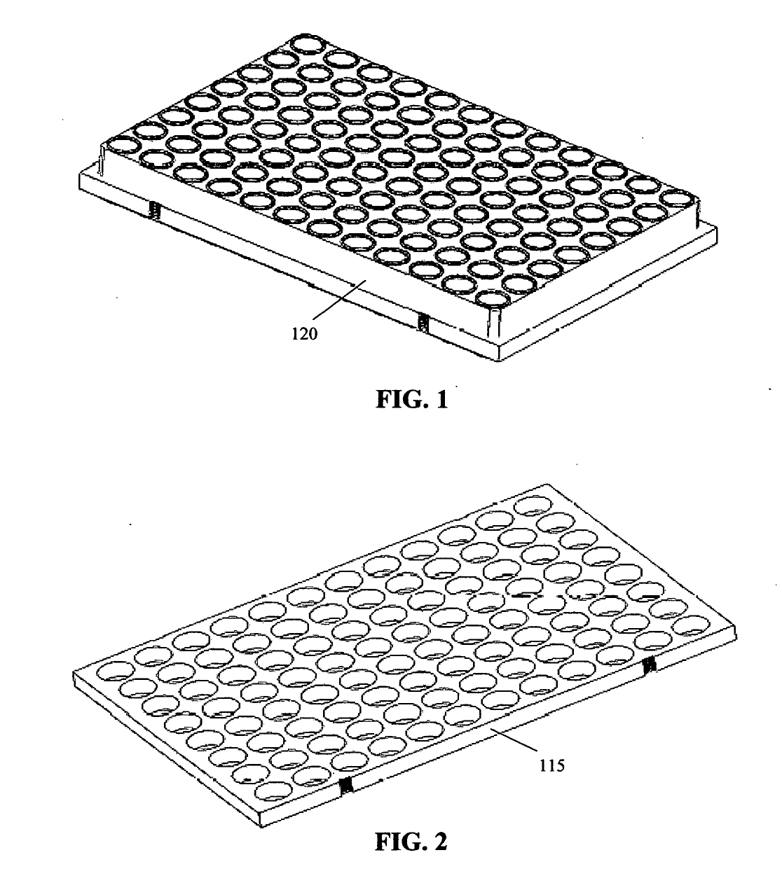

FIG. 1 shows a bottomless elastomeric microarray with internal frame (120) comprised of an internal frame (115) (FIG. 2) encapsulated with an elastomeric material which provides for a bottomless elastomeric microarray with internal frame (120).

FIG. 2 depicts the internal frame (115) without the encapsulating elastomeric material. The bottomless elastomeric microarray with internal frame (120), (FIG. 1) is manufactured by over-molded or co-injecting an elastomeric material onto the internal frame (115) by transfer, compression or injection molding. The internal frame (115) is produced from a rigid or semi rigid metal, thermoplastic or thermoset material.

There exists a mechanical and/or chemical bond between the internal frame (115) and encapsulating elastomeric material forming the bottomless elastomeric microarray with internal frame (120). This mechanical and/or chemical bond is created during the elastomeric curing or cooling process. The elastomeric material used to fabricate the bottomless elastomeric microarray with internal frame (120) can be transparent, translucent or opaque and can be produced in a multitude of colors. One preferred embodiment of the bottomless elastomeric microarray with internal frame (120) includes the use of silicone rubber or PDMS.

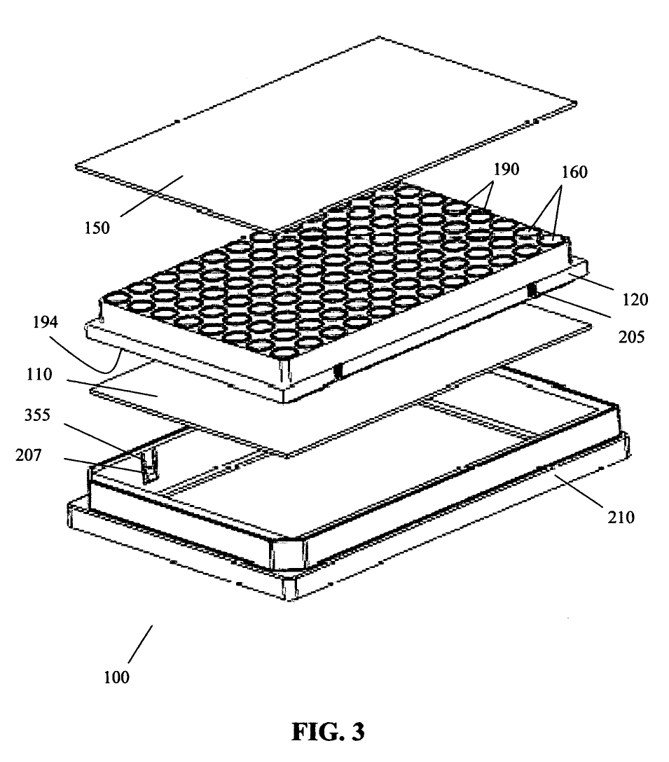

FIG. 3 is a “blown-up” assembly drawing of the completely assembled three component 96 well microarray device (100) with 96 watertight individual reservoir well(s) (160) and optional top sealing plate (150). The rigid or semi rigid base housing (210) is fabricated to accept the transparent bottom plate (110). The transparent bottom plate (110) is either glass, a transparent thermoplastic or transparent thermoset plate. The single element bottomless elastomeric microarray with internal frame (120) is inserted into the base housing (210) on top of the transparent bottom plate (110).

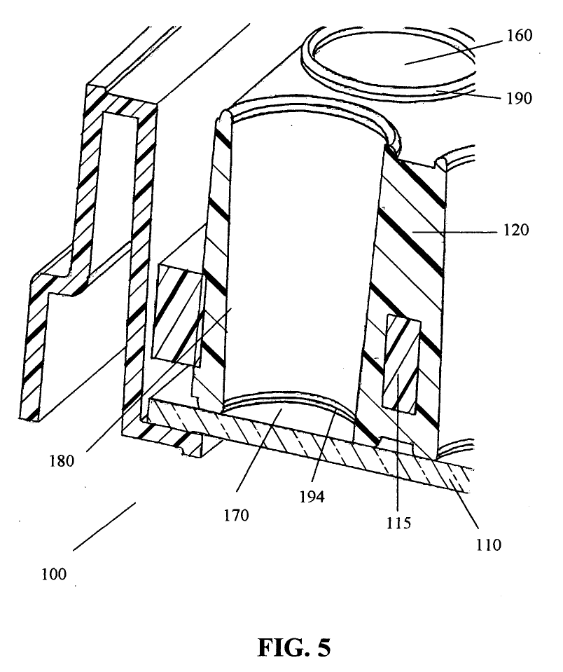

A mechanical latching interface (207) is created between an integrated internal frame graduated latching detail (205) and the base housing latching detail (355) to form an assembled three component 96 well microarray device (100). The bottomless elastomeric microarray with internal frame (120) is fabricated with a protruding well underside sealing gasket (194) (FIG. 5) extending down from the circumference of the individual reservoir well(s) (160). The well underside sealing gasket (194) is compressed by the downward force created by the mechanical latching interface (207) forming 96 watertight individual reservoir well(s) (160).

The upper portion of each individual reservoir well(s) (160) has a integrated well upper sealing gasket (190) protruding up from the circumference of each individual reservoir well(s) (160). An optional top sealing plate (150) produced from transparent glass, thermoplastic or thermoset, seals against the well upper sealing gasket (190) and is optionally employed to prevent well cross contamination and/or long term microarray storage.

In a preferred embodiment the transparent bottom plate (110) is produced from optically clear, transparent glass for underside microscopy or other microarray inspection device interpretation.

The disclosed assembled three component 96 well microarray device (100) invention can be replicated in a multitude of well formats including, but not limited to, a 1, 2, 8, 16, 96, 384 or 1536 well microtiter plate footprint. The individual reservoir well(s) (160) can be square, round or irregular in shape. In all cases a transparent bottom plate (110) and bottomless elastomeric microarray with internal frame (120) are assembled within a rigid or semi rigid base housing (210). The assembled three component 96 well microarray device (100) depicted in FIG. 3 is designed and manufactured to the industry standard form factor defined by the Society of Biomolecular Sciences.

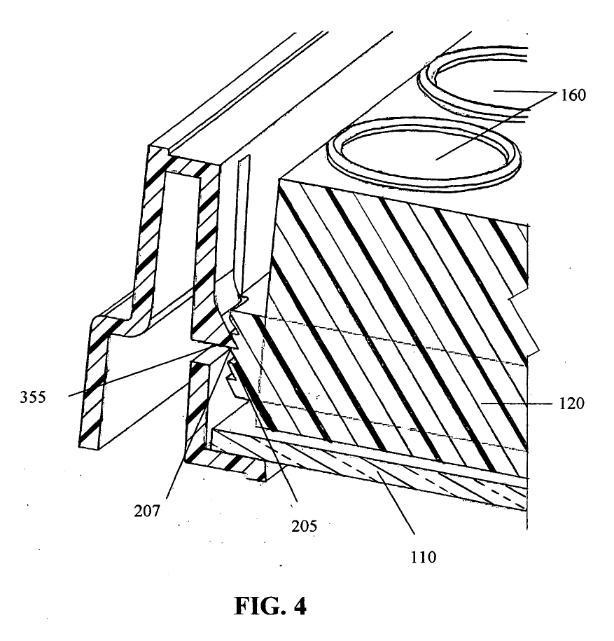

FIG. 4 is a close up cross sectional view revealing the microarray mechanical latching interface (207) comprised of the internal frame graduated latching detail (205) and base housing latching detail (355). The mechanical latching interface (207) is responsible for providing the compressive force between the bottomless elastomeric microarray with internal frame (120) and transparent bottom plate (110) forming 96 watertight individual well(s) (160).

FIG. 5 is a close up cross sectional view of an individual reservoir well(s) (160) in an assembled three component 96 well microarray device (100). The compressive force generated by the mechanical latching interface (207) is transferred to the individual well underside sealing gaskets (194) through the internal frame (115) of the bottomless elastomeric microarray with internal frame (120). The well underside sealing gasket (194) is shown compressed against the transparent bottom plate (110) providing the watertight seal for the individual reservoir well(s) (160).

FIG. 5 also reveals the internal frame (115) predominately encapsulated by elastomeric material forming the bottomless elastomeric microarray with internal frame (120) and integrated well upper sealing gasket (190). The individual reservoir well(s) (160) are comprised of two materials, the elastomeric individual well sidewall (180) with well underside sealing gasket (194) and the individual reservoir well bottom surface (170) formed by the transparent bottom plate (110).

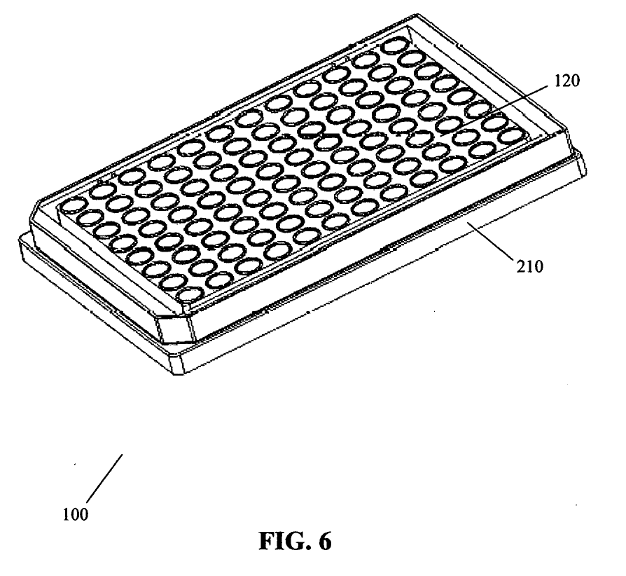

FIG. 6 reveals an assembled three component 96 well microarray device (100) consisting of a rigid base housing (210), a transparent bottom plate (110) and a bottomless elastomeric microarray with internal frame (120).

### REFERENCE NUMERALS

100 Assembled Three Component 96 Well Microarray Device
110 Transparent Bottom Plate
115 Internal Frame
120 Bottomless Elastomeric Microarray with Internal Frame
150 Top Sealing Plate
160 Individual Reservoir Well
170 Individual Reservoir Well Bottom Surface
180 Individual Well Sidewall
194 Well Underside Sealing Gasket
205 Internal Frame Graduated Latching Detail
207 Mechanical Latching Interface
210 Base Housing
355 Base Housing Latching Detail

What is claimed is:

1. A microarray device for testing of biological or pharmaceutical samples, said microarray device comprising a base housing, a rigid transparent bottom plate, and a bottomless elastomeric microarray structure with internal frame, wherein said base housing and said internal frame are mechanically latched together thereby attaching said transparent bottom plate to said microarray structure thus forming a specified number of watertight elastomeric microarray reservoir wells.

2. The microarray device of claim 1, wherein said microarray device includes, but is not limited to 1, 2, 8, 16, 96, 384 or 1536 reservoir wells per said microarray with said rigid transparent bottom plate enabling microscopy inspection of individual reservoir wells.

3. The microarray device of claim 1, wherein said bottomless elastomeric microarray structure with internal frame is produced primarily from transparent, translucent or opaque elastomer.

4. The microarray device of claim 1, wherein said bottomless elastomeric microarray structure with internal frame is produced primarily from silicone rubber.

5. The microarray device of claim 1, wherein said transparent rigid plate is transparent rigid plate glass.

6. The microarray device of claim 1, wherein said transparent rigid plate is a thermoplastic or thermoset material.

7. The microarray device of claim 1, wherein said transparent rigid plate is coated with a biological or pharmaceutical agent prior to completion of microarray device assembly.

8. The microarray device of claim 1, wherein a water tight seal exists due to the compressive forces generated by a latching mechanism attaching said transparent bottom plate to said microarray structure.

9. The microarray device of claim 1, wherein a series of individual elastomeric well underside sealing gaskets are fabricated within said bottomless microarray elastomeric structure with internal frame.

10. The microarray device of claim 1, wherein a series of individual well top sealing gaskets are fabricated within said bottomless microarray elastomeric structure with internal frame wherein said top sealing gaskets seal against a top sealing plate.

11. The microarray device of claim 1, wherein said device complies with the form factor as defined by The Society of Biomolecular Sciences, thereby accommodating existing bio-science spotting automation and equipment.

12. The microarray device of claim 1, wherein an upper portion of each individual reservoir well includes an integrated well upper sealing gasket protruding up from the circumference of each said individual reservoir well.

13. The microarray device of claim 1, wherein said well also includes a top sealing plate produced from transparent glass, wherein thermoplastic or thermoset seals against said well upper sealing gasket may be employed to prevent well cross contamination or provide for long term storage.

14. A microarray device for testing of biological or pharmaceutical samples, said microarray device comprising a base housing, a rigid transparent bottom plate, and a bottomless elastomeric microarray structure with internal frame, wherein said base housing and said internal frame are mechanically latched together thus forming a specified number of watertight elastomeric microarray reservoir wells such that merely the compressive force generated by a latching interface between said transparent bottom plate and said microarray structure creates a series of water tight seals against said transparent bottom plate.

15. A microarray device as in claim 14, wherein said elastomeric well structure creates a top sealing gasket for a top sealing plate, thereby limiting cross contamination between said individual reservoir wells and any microarray storage.

16. A microarray device as in claim 14, wherein a series of individual elastomeric well underside sealing gaskets are fabricated within said bottomless microarray elastomeric structure with internal frame.

17. A method of manufacturing a bottomless elastomeric microarray structure with internal frame, wherein an elastomeric material is over-molded or co-injected onto said internal frame by transfer, compression or injection molding, producing said bottomless elastomeric microarray structure with internal frame.

18. The method of claim 17, wherein said elastomeric material is silicone rubber.

19. The method of claim 17, wherein said internal frame comprises a rigid, semi-rigid metal, a thermoplastic or thermoset material.
